(19) United States
(12) Patent Application Publication
(10) Pub. No.: US 2026/0095924 A1
(43) Pub. Date: Apr. 2, 2026

(54) METHOD, DEVICE, AND MEDIUM FOR COMMUNICATION

(71) Applicant: NEC CORPORATION, Tokyo (JP)

(72) Inventors: Zhaobang MIAO, Beijing (CN); Gang WANG, Beijing (CN)

(73) Assignee: NEC CORPORATION, Tokyo (JP)

(21) Appl. No.: 19/113,285

(22) PCT Filed: Sep. 21, 2022
(86) PCT No.: PCT/CN2022/120321

§ 371 Date: Mar. 19, 2025

(51) Int. Cl. H04W 72/25; H04L 5/00

(52) U.S. Cl. CPC H04W 72/25; H04L 5/0094

(57) ABSTRACT

Example embodiments of the present disclosure relate to a solution for transport block size (TBS) determination for sidelink communication. In this solution, a first terminal device determines a sub-channel comprising a first number of resource block (RB) interlaces and each of the first number of RB interlaces having a target interlace size. The first terminal device determines a transport block size (TBS) for at least one transmission of a transport block (TB) for SL-U communication based on a target criterion associated with the sub-channel. The first terminal device then transmits the at least one transmission of the TB to a second terminal device based on the TBS. In this way, the interlaced RB-based transmission and contiguous RB-based transmission in SL-U are improved in terms of resource allocation, TBS determination, blind decoding as well as resource efficiency.

### FIELD

Example embodiments of the present disclosure generally relate to the field of communication techniques and in particular, to a method, device, and medium for sidelink communication.

### BACKGROUND

In 5G NR, sidelink communication has been developed on unlicensed spectrum, which is also called SL-U. In SL-U, both interlaced resource block (RB)-based transmission and contiguous RB-based transmission are supported. The resource allocation granularity in frequency domain for SL-U is a sub-channel for Physical Sidelink Shared Channel (PSSCH). For interlaced RB-based transmission, one sub-channel may consist of one or more interlaces. Depending on a specific channel configuration and overhead, sub-channels may vary from the number of interlaces and even the number of physical resource blocks (PRBs) contained in each interlace. For contiguous RB-based transmission, the division of sub-channels is independent of the division of resource sets in a resource pool. Therefore, SL-U is expected to be improved in terms of resource allocation, transport block size (TBS) determination as well as utilization efficiency.

### SUMMARY

In general, embodiments of the present disclosure provide methods, devices and computer storage medium for TBS determination in sidelink communication.

In a first aspect, there is provided a communication method performed by a first terminal device. The communication method comprises: determining, at a first terminal device, a sub-channel comprising a first number of resource block (RB) interlaces and each of the first number of RB interlaces having a target interlace size; determining, based on a target criterion associated with the sub-channel, a transport block size (TBS) for at least one transmission of a transport block (TB) for sidelink communication; and transmitting, to a second terminal device and based on the TBS, the at least one transmission of the TB.

In a second aspect, there is provided a communication method performed by a second terminal device. The communication method comprises: determining, at a second terminal device, a sub-channel comprising a first number of resource block (RB) interlaces and each of the first number of RB interlaces having a target interlace size; determining, based on a target criterion associated with the sub-channel, a transport block size (TBS) for at least one transmission of a transport block (TB) for sidelink communication; and receiving, from a first terminal device and based on the TBS, the at least one transmission of the TB.

In a third aspect, there is provided a communication method performed by a first terminal device. The communication method comprises: obtaining, at the first terminal device, a sub-channel configuration for a resource block (RB) set allocated for sidelink-unlicensed (SL-U) communication; determining, based on the sub-channel configuration and a configuration of at least one RB set, a group of sub-channels for each of the at least one RB set, a starting position of the group sub-channels being aligned with a starting position of each RB set in frequency domain; and transmitting, to a second terminal device and based on the group of sub-channels, at least one transmission of a transport block (TB).

In a fourth aspect, there is provided a communication method performed by a second terminal device. The communication method comprises: obtaining, at the second terminal device, a sub-channel configuration for a resource block (RB) set allocated for sidelink-unlicensed (SL-U) communication; determining, based on the sub-channel configuration and a configuration of at least one RB set, a group of sub-channels for each of the at least one RB set, a starting position of the group sub-channels being aligned with a starting position of each RB set in frequency domain; and receiving, from a first terminal device and based on the group of sub-channels, at least one transmission of a transport block (TB).

In a fifth aspect, there is provided a communication device. The communication device includes a processing unit; and a memory coupled to the processing unit and storing instructions thereon, the instructions, when executed by the processing unit, causing the device to perform the method according to the first aspect.

In a sixth aspect, there is provided a communication device. The communication device includes a processing unit; and a memory coupled to the processing unit and storing instructions thereon, the instructions, when executed by the processing unit, causing the device to perform the method according to the second aspect.

In a seventh aspect, there is provided a communication device. The communication device includes a processing unit; and a memory coupled to the processing unit and storing instructions thereon, the instructions, when executed by the processing unit, causing the device to perform the method according to the third aspect.

In an eighth aspect, there is provided a communication device. The communication device includes a processing unit; and a memory coupled to the processing unit and storing instructions thereon, the instructions, when executed by the processing unit, causing the device to perform the method according to the fourth aspect.

In a ninth aspect, there is provided a computer readable medium having instructions stored thereon, the instructions, when executed on at least one processor, causing the at least one processor to carry out the method according to the first aspect.

In a tenth aspect, there is provided a computer readable medium having instructions stored thereon, the instructions, when executed on at least one processor, causing the at least one processor to carry out the method according to the second aspect.

In an eleventh aspect, there is provided a computer readable medium having instructions stored thereon, the instructions, when executed on at least one processor, causing the at least one processor to carry out the method according to the third aspect.

In a twelfth aspect, there is provided a computer readable medium having instructions stored thereon, the instructions, when executed on at least one processor, causing the at least one processor to carry out the method according to the fourth aspect.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication environment in which example embodiments of the present disclosure can be implemented;

FIG. 2 illustrates a diagram of an example method for sidelink according to some embodiments of the present disclosure;

FIG. 3A and FIG. 3B illustrate schematic diagrams of example configurations for interlace RB-based transmission in SL-U according to some embodiments of the present disclosure;

FIG. 4A illustrates a schematic diagram of an example configuration of sub-channel in sidelink according to some embodiments of the present disclosure;

FIG. 4B illustrates a schematic diagram of an example configuration for interlace RB-based transmission in sidelink according to some embodiments of the present disclosure;

FIG. 5 illustrates a schematic diagram of an example configuration for interlace RB-based transmission in sidelink according to some further embodiments of the present disclosure;

FIG. 6 illustrates a diagram of an example method for sidelink according to some embodiments of the present disclosure;

FIG. 7 illustrates a schematic diagram of an example configuration for contiguous RB-based transmission in sidelink according to some embodiments of the present disclosure;

FIG. 8 illustrates a diagram of an example method for sidelink according to some embodiments of the present disclosure;

FIG. 9 illustrates a diagram of an example method for sidelink according to some embodiments of the present disclosure; and

FIG. 10 illustrates a simplified block diagram of an apparatus that is suitable for implementing example embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, devices on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g., FRI (410 MHz to 7125 MHZ), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, channel emulator.

In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As used herein, the term “resource,” “transmission resource,” “uplink resource,” or “downlink resource” may refer to any resource for performing a communication, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the terms “RB interlace” and “interlace RBs” refer to RBs {m, M+m, 2M+m, 3M+m, . . . }, where m is the interlace index, and M is the number of interlaces given by Table 1 below. In the context of the present disclosure, the terms “RB interlace” and “interlace RBs” are used interchangeably.

TABLE 1
The number of RB interlace

| Subcarrier Spacing | |
|---|---|
| Configuration μ | M |
| 0 | 10 |
| 1 | 5 |

It is expected to reuse the NR sidelink and NR-U channel structure for SL-U. In NR sidelink, a resource pool includes consecutive physical resource blocks (PRBs) in frequency domain. In particular, a resource pool may be defined by a start RB, which is the lowest RB of the resource pool, denoted by sl-StartRB-Subchannel, and the total number of RBs in the resource pool, denoted by sl-RB-Number. The sub-channel is the frequency resource unit for PSSCH, and each sub-channel consists of consecutive RBs. For example, a sub-channel may be of a size, i.e., SubchannelSize=[10,12,15,20,25,50,75,100] RBs.

In NR-U, the system band is divided into multiple RB sets by several guard bands, and one bandwidth part (BWP) may contain one or more RB sets. Depending on the sub-carrier space (SCS), RB sets may contain different numbers of RBs, for example, 100 to 110 RBs per RB set for SCS=15 KHz, 50 to 55 RBs per RB set for SCS=30 KHz, etc.

As previously mentioned, both contiguous RB-based transmission and interlace RB-based transmission are supported in NR sidelink. For interlace RB-based transmission in SL-U, the resource allocation granularity in frequency domain is the sub-channel for PSSCH, and each sub-channel may consist of K RB interlaces, where K is fixed to be 1, or alternatively, K is a preconfigured integer. In one embodiment, a sub-channel may be confined within an RB set. Alternatively, in some other embodiments, a sub-channel may span one or more RB sets which belong to a resource pool.

For interlaced Physical Uplink Shared Channel (PUSCH) transmission in a BWP, Y bits of a frequency domain resource allocation (FDRA) field indicates which RB sets are allocated to the UE, and the allocated RB sets correspond to Listen-Before-Talk (LBT) bandwidths. This applies to the PUSCH of the following types:
PUSCH scheduled by at least one non-fallback downlink control information (DCI);
Configured Grant PUSCH Type 2, i.e., FDRA indicate by DCI);
Configured Grant PUSCH Type 1, i.e., FDRA configured by radio resource control (RRC).

Accordingly, the UE may determine an overall PUSCH frequency domain resource allocation by the intersection of the following:
Allocated interlaces, which is indicated by X bits of the FDRA field,
Available PRBs derived at least from the allocated RB sets, which is indicated by Y bits of the FDRA field, and intra-carrier guard bands between RB sets corresponding to contiguous LBT bandwidths.

Note, an RB set contains PRBs within an LBT bandwidth and does not include any inter or intra carrier guard PRBs. The PRBs between adjacent RB sets comprise an intra-carrier guard.

In one embodiment, Y is determined by the number of RB sets contained in the BWP. Y bits indicate a first RB set and a number of RB sets corresponding to contiguous LBT bandwidths. The maximum possible value of Y is thus

$$⌈ {log}_{2} ( \frac{N ( N + 1 )}{2} ) ⌉ ,$$

where N is the number of RB sets contained in the BWP.

In one embodiment, a TBS determination procedure for Physical Downlink Shared Channel (PDSCH) may be reused for TBS determination in sidelink.

For Physical Sidelink Feedback Channel (PSFCH) overhead in the TBS determination, the number of PSFCH symbols indicated by SCI is used. For PSSCH Demodulation Reference Signal (DMRS) overhead in the TBS determination, the reference number of REs occupied by PSSCH DMRS is used, where the reference number of REs is an average number of DMRS REs among configured or preconfigured patterns. For Channel-State-Information Reference Signal (CSI-RS) and Phase Track Reference Signal (PT-RS) overheads in the TBS determination, a new higher layer parameter, e.g., sl-xOverhead, is introduced per resource pool.

In one embodiment, for PSCCH and PSSCH in SL-U, the number of PRBs for each sub-channel may be different, considering aspects of TBS determination, UE blind decoding, etc. Therefore, for interlace RB-based transmission, different interlaces may have different numbers of PRBs. However, it is not expected for a UE to receive a retransmission with a TB size that is different from the last valid TB size signaled for this TB. For contiguous RB-based transmission, the number of PRBs within a resource pool may not be an integer multiple of the number of PRBs for a sub-channel, which causes a waste of frequency resource.

Embodiments of the present disclosure provide a solution for resource allocation and determination in sidelink communication. In the present solution, for interlace RB-based transmissions, TBS determination for multiple transmissions of a TB is based on a consistent or deterministic sub-channel size and interlace size. Moreover, for contiguous RB-based transmission, the sub-channels for each RB set are individually defined based on a respective RB set configuration. In this way, resource efficiency, the blind decoding, system performance for sidelink can be improved.

Principles and implementations of the present disclosure will be described in detail below with reference to the figures.

### Example of Communication Network

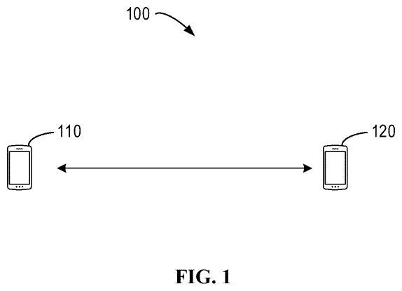

FIG. 1 illustrates a schematic diagram of an example communication environment 100 in which example embodiments of the present disclosure can be implemented.

The communication environment 100 includes a first terminal device 110 and a second terminal device 120. The first terminal device 110 and the second terminal device 120 may communicate with each other via sidelink. In some cases, the communication environment 100 may further include a network device (not shown) serving the first terminal device 110 and the second terminal device 120.

It is to be understood that the number of devices and their connections in FIG. 1 are given for the purpose of illustration without suggesting any limitations to the present disclosure. The communication environment 100 may include any suitable number of network devices and/or terminal devices adapted for implementing implementations of the present disclosure.

The communications in the communication environment 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In some embodiments, the first terminal device 110 and the second terminal device 120 may communicate with each other via a sidelink channel on unlicensed spectrum. A sidelink is a communication mode that allows direct communications between two or more terminal devices without the communications going through network device.

SL communications may be carried out on a wireless interface, e.g., PC5 interface. SL communications may be unicast, groupcast, or broadcast, and may be used for device-to-device (D2D) communications, vehicle-to-everything (V2X) communications, emergency rescue applications, etc. The sidelink channel may include, but not limited to, a Physical Sidelink Feedback Channel (PSFCH), a Physical Sidelink Shared Channel (PSSCH), a Physical Sidelink Control Channel (PSCCH), and a Physical Sidelink Broadcast Channel (PSBCH) etc.

In the context of the embodiments, the first terminal device 110 may act as a transmitting (Tx) device that transmits at least one transmission of a TB to the second terminal device 120. Accordingly, the second terminal device may act as a receiving (Rx) device. However, it should be understood that in some cases, the first terminal device 110 may act as the Rx device while the second terminal device 120 may act as the Tx device.

Depending on whether covered within a serving area of a network device or not, sidelink communication scenarios may include in-coverage, partial-coverage, and out-of-coverage (OOC). In some cases, the communication network 100 may further include a network device (not shown in FIG. 1) that facilitates the scheduling of resources for sidelink communications. In other cases, sidelink communications are carried out between the first terminal device 110 and the second terminal device 120 without the involvement of a network device.

Sidelink resource allocation schemes may be applied for allocating resources in a resource pool for sidelink communications. There may be two sidelink resource allocation schemes. In a first sidelink resource allocation scheme, which is also referred to as Mode 1 for sidelink resource allocation, the network device may schedule sidelink resources via the communication interface with the terminal device 110 or 120. The resource allocation may include dynamic grant, for example, by downlink control information (DCI), or configured grant (e.g., Type 1 or Type 2 configured grant). In a second SL resource allocation scheme, which is also referred to as Mode 2 for sidelink resource allocation, the resources for sidelink communications may be autonomously selected by the terminal devices 110 and 120 based on a contention scheme.

In some embodiments, the first terminal device 110 may transmit interlaced RB-based transmission to the second terminal device 120. Additionally, or alternatively, in some other embodiments, the first terminal device 110 may transmit contiguous RB-based transmission to the second terminal device 120. Before any transmission, the first terminal device 110 may determine the TBS for transmission or retransmission of the TB, which will be discussed in detail below.

### Work Principle and Example Process

Example embodiments of the present disclosure provide a solution for resource allocation and determination for sidelink communication. In this solution, a TBS for at least one transmission of a TB is determined according to a target criterion. As such, multiple transmissions of the TB including initial transmission and one or more retransmissions are performed based on a consistent or deterministic TBS. In other words, the TBS for the multiple transmissions has a consistent size in either interlace level or in PRB level.

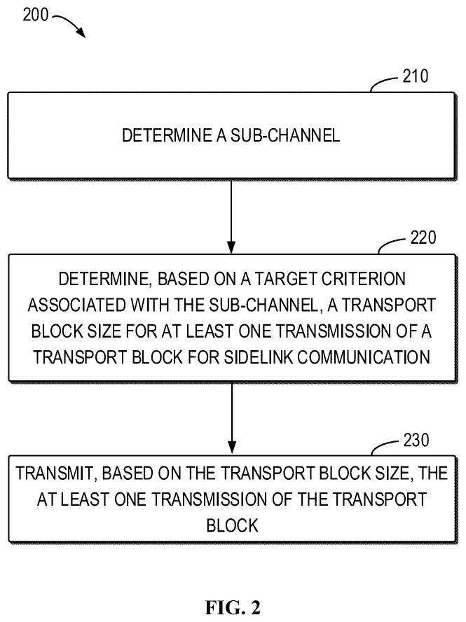

Reference is made to FIG. 2, which illustrates a flowchart of a process 200 for communication according to some example embodiments of the present disclosure. For the purpose of discussion, the process 200 will be described with reference to FIG. 1. The process 200 may be implemented at the first terminal device 110 and involve the second terminal device 120.

In the process 200, sidelink communication between the first terminal device 110 and the second terminal device 120 is based on interlace RB-based transmission. At block 210, the first terminal device 110 determines a sub-channel. The subchannel comprises a first number of RB interlaces, and each of the first number of RB interlaces has a target interlace size.

At block 220, the first terminal device 110 determines, based on a target criterion associated with the sub-channel, a TBS for at least one transmission of a TB for sidelink transmission.

In some example embodiments, the first terminal device 110 may determine the TBS based on the first number of RB interlaces and the target interlace size.

At block 230, the first terminal device 110 transmits, to the second terminal device 120 and based on the TBS, the at least one transmission of the TB.

In some embodiments, at least one RB set is allocated for the sidelink communication. The first number of RB interlaces are within each of the at least one RB set or across a plurality of the RB sets.

In some embodiments, a consistent size of sub-channel may be defined and supported within an RB set for sidelink communication, for example, a sub-channel contains K interlaces, where K corresponds to the first number in the process 200. This effectively avoids the situation that different sub-channels may contain different number of interlaces.

In some example embodiments, the value of K may be defined based on the SCS in the resource pool for the first terminal device 110 and the second terminal device 120. By way of example, a set of candidate numbers of RB interlace may be predetermined based on the SCS, and the value of K is preconfigured or configured via a RRC parameter.

In these embodiments, the first terminal device 110 may receive a configuration of the first number of RB interlaces for the sub-channel from the set of candidate numbers of RB interlace. The set of candidate numbers are corresponding to the SCS for the at least one RB set. The first terminal device 110 may then determine the TBS based on the first number of RB interlaces.

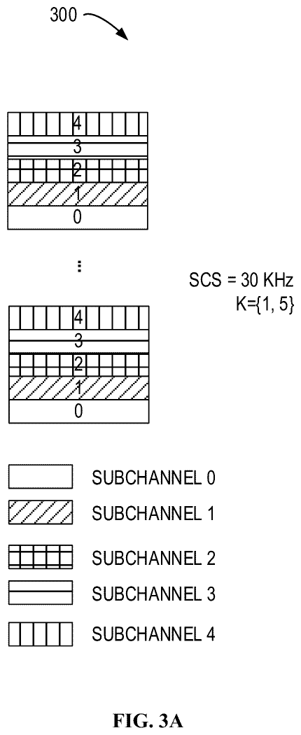

FIG. 3A and FIG. 3B illustrate schematic diagrams of example configurations for interlace RB-based transmission in sidelink according to some embodiments of the present disclosure. In the examples shown in FIGS. 3A and 3B, where SCS=30 KHz and each RB set may contain 50 to 55 RBs, a set of candidate numbers of RB interlace for SCS=30 KHz is {1, 5}. The set of candidate numbers are integers that are divisible by the number of interlaces for the at least one RB set. The value of K is selected from {1, 5} and indicated via a RRC parameter. In this way, each sub-channel may have the same number of interlaces.

In the example configuration 300, K=1, and thus each sub-channel consists of one interlace, where interlace 0 for sub-channel 0, interlace 1 for sub-channel 1, interlace 2 for sub-channel 2, interlace 3 for sub-channel 3, interlace 4 for sub-channel 4, and so on. In the example configuration 310, K=5, and thus each sub-channel consists of five interlaces, where the first contiguous five interlaces 0 to 4 for sub-channel 0, the second contiguous five interlaces 0 to 4 for sub-channel 1, and so on.

In the example configuration where SCS=15 KHz and each RB set may contain 100 to 110 RBs, a set of candidate numbers of RB interlace for SCS=15 KHz is {1, 2, 5, 10}. Similarly, the value of K is selected from {1, 2, 5, 10} and indicated via the RRC parameter.

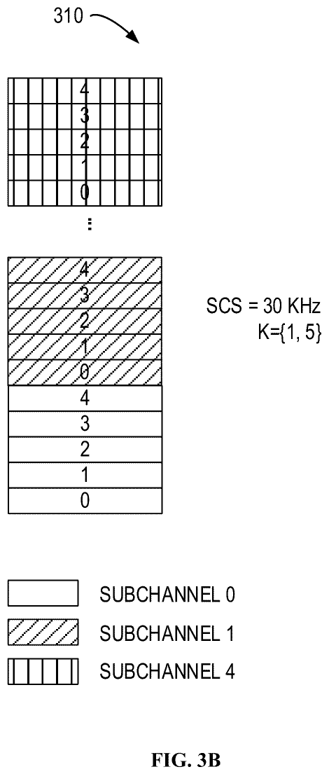

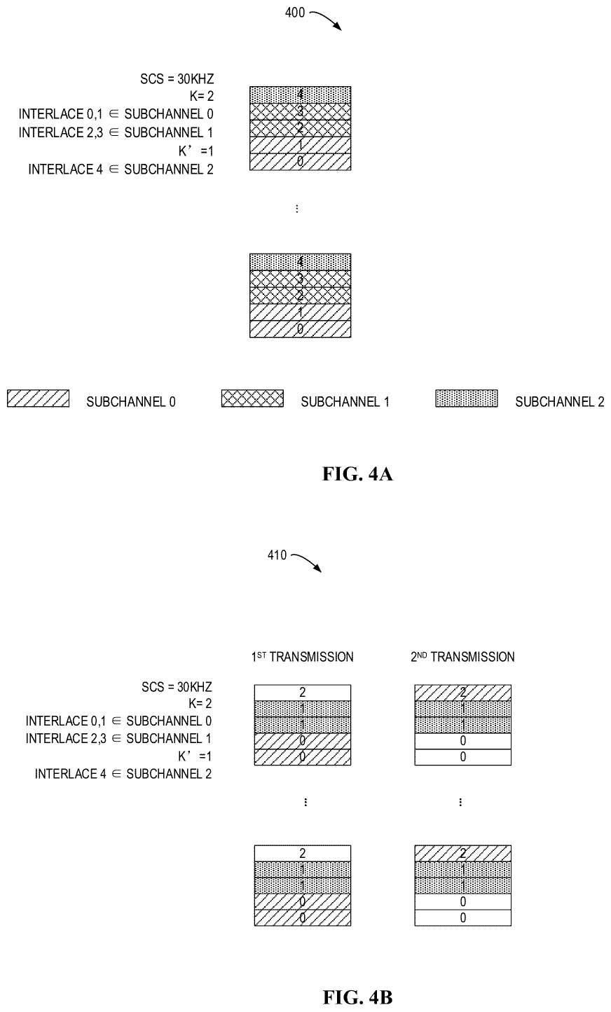

In some embodiments, an inconsistent size of sub-channel may be defined and supported within an RB set for sidelink communication. FIG. 4A illustrates a schematic diagram of an example configuration 400 of sub-channel in sidelink according to some embodiments of the present disclosure. As shown in FIG. 4A, an RB set associated with sidelink communication may comprises three sub-channels 0 to 2, where sub-channel 0 and sub-channel 1 each consist of 2 interlaces, i.e., K=2, while sub-channel 2 consists of 1 interlace, i.e., K′=1.

To support a same TBS among multiple transmission or retransmissions, in some example embodiments, the first terminal device 110 may assume that each sub-channel has the same number of RB interlaces in determining TBS. For example, the first number (e.g., M) of RB interlaces is assumed across all the sub-channels. In this case, the assumed sub-channel for TBS determination may differ from the actual sub-channel configured for the sidelink communication, and the assumed sub-channel size is only used for TBS determination. Additionally, or selectively, the first terminal device 110 may further adjust the code rate based on the determined TBS.

In some embodiments, the first number M may be the value of K, the value of K′, an average value of K or K′, an average value of interlace numbers across all the sub-channels in the RB set, or any other suitable value by pre-configuration. In the example of FIG. 4A, M may be selected from {1, 3/2, 5/3, 2}.

FIG. 4B illustrates a schematic diagram of an example configuration 410 for interlace RB-based transmission in sidelink according to some embodiments of the present disclosure. As shown in FIG. 4B, for the first transmission, which refers to a transmission of the TB that is relatively advanced in time and may be either the initial transmission or a retransmission, sub-channel 0 and sub-channel 1 each consist of 2 interlaces, i.e., K=2, while sub-channel 2 consists of 1 interlace, i.e., K′=1. In determining TBS for the second transmission, which refers to a transmission of the TB that is later in time and may be a retransmission, sub-channel 2 is considered to have K=2 interlaces. In other words, even for a sub-channel that contains relatively less interlaces, i.e., K′<K, the first terminal device 110 assumes that sub-channel contains M interlaces in TBS determination.

In some example embodiments, the first terminal device 110 may indicate the interlace number of each sub-channel of the PSSCH for different transmissions of the TB via sidelink control information (SCI). In this case, the interlace number may keep the same across multiple transmissions or retransmissions of the TB for TBS determination. In this case, upon receiving the SCI, the second terminal device 120 is aware of the interlace size for each interlace for a respective one of the plurality of transmissions of the TB.

Moreover, the number of PRBs contained in one RB interlace may be also taken into consideration for TBS determination. In some embodiments, a consistent interlace size is defined and supported for sidelink communication. By way of example, a interlace size of 10 PRBs may be allowed across all the RB sets. In this case, the TBS may keep the same among multiple transmissions of the TB.

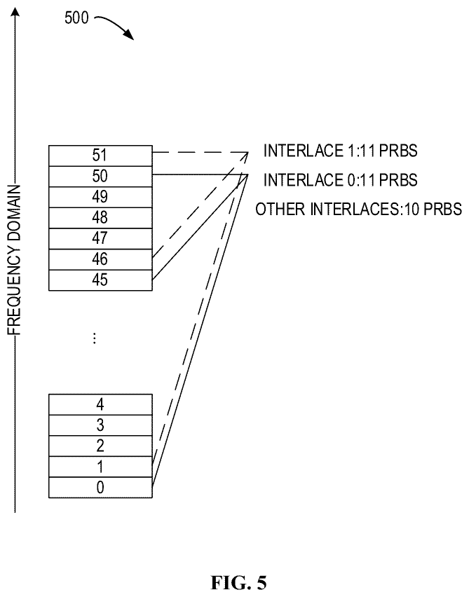

By way of another example, the first terminal device 110 may allow a consistent interlace size of 10 PRBs or 11 PRBs per one RB set. FIG. 5 illustrates a schematic diagram of an example configuration 500 for interlace RB-based transmission in sidelink according to some further embodiments of the present disclosure. As shown in FIG. 5, interlace 0 and interlace 1 each consist of 11 PRBs, while the rest of the interlaces 2 to 9 consist of 10 PRBs. To keep a consistent interlace size in TBS determination, the first terminal device 110 is not to use the last few PRBs, which may be determined as (N_PRB mod 5) for SCS=30 KHz and as (N_PRB mod 10) for SCS=15 KHz, where N_PRB is the number of PRBs in a RB set.

Additionally, or alternatively, in the above embodiments, it is possible for one RB set associated with an interlace size of 10 PRBs while another RB set associated with an interlace size of 11PRBs. In this case, the first terminal device 110 may always use the RB sets which have the same interlace size for multiple transmissions of the same TB.

In some embodiments, an inconsistent interlace size is defined and supported for sidelink communication. In this case, the first terminal device 110 may allow two interlace sizes, e.g., 10 PRBs and 11 PRBs. To support the same TBS for multiple transmissions of the TB, the first terminal device 110 may assume that each interlace contains the same number of PRBs in determining TBS. For example, each interlace may be assumed to contain a predefined number (e.g., N) of PRBs. Accordingly, the assumed interlace size for TBS determination may differ from the actual interlace size configured for the sidelink communication, and the assumed interlace size is only used for TBS determination. Additionally, or selectively, the first terminal device 110 may further adjust the code rate based on the determined TBS.

In some embodiments, the predefined number N may be any of the actual interlace sizes (e.g., 10 PRBs, 11 PRBs, etc.), or an average of the actual interlace sizes, or any suitable interlace size by pre-configuration. In the example of FIG. 5, N may be selected from {10, 10.5, 11}.

In some embodiments, in determining a TBS for a retransmission of the TB, the first terminal device 110 may directly use the TBS determined or used for an initial transmission or a previous retransmission. In this case, the transmitting device can avoid re-calculating the TBS based on PRBs or REs, thus the computation complexity and overhead can be further improved.

Alternatively, in some embodiments, the first terminal device 110 may indicate the number of PRBs of each interlace of the PSSCH for different transmissions of the TB via SCI. In this case, the number of PRBs of each interlace may keep the same across multiple transmissions or retransmissions of the TB for TBS determination. In this case, upon receiving the SCI, the second terminal device 120 is aware of the number of PRBs for each interlace.

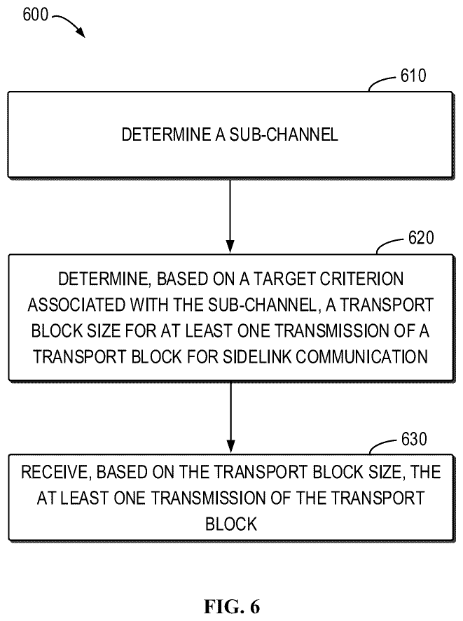

From the perspective of second terminal device 120, since the target criterion is also used in determining TBS, the same TBS will be obtained for multiple transmissions of the TB, which will be described in detail below in connection with FIG. 6.

It would be appreciated that the examples, configurations and structures in FIG. 3A to FIG. 5 are given for the purpose of illustration. There will be many variants to resource allocation in frequency domain, and the scope of the present disclosure is not limited in this regard.

Through this solution, a consistent and deterministic TBS can be obtained for multiple transmissions of PSSCH in sidelink, which is especially beneficial to resource determination and blink decoding in SL-U. In this way, the interlaced resource block (RB)-based transmission is improved in terms of communication reliability, TBS determination, blind decoding as well as resource efficiency.

FIG. 6 illustrates a flowchart of an example method 600 in accordance with an embodiment of the present disclosure. The method 600 can be implemented at any suitable terminal devices. Only for the purpose of discussion, the method 600 will be described with reference to FIG. 1. For example, the method 600 may be implemented at the second terminal device 120.

At block 610, the second terminal device 120 determines a sub-channel. The sub-channel comprises a first number of RB interlaces and each of the first number of RB interlaces having a target interlace size.

At block 620, the second terminal device 120 determines, based on a target criterion associated with the sub-channel, a TBS for at least one transmission of a TB for sidelink communication. The at least one transmission may be based on interlaced RB-based transmission.

For example, the at least one transmission of the TB may comprise at least one of the following: an initial transmission of the TB, at least one retransmission of the TB.

In some embodiments, the target criterion may be predetermined at the first terminal device 110 and the second terminal device 120. Alternatively, or additionally, the target criterion is indicated via at least one RRC parameter.

In some embodiments, at least one RB set may be allocated for the sidelink communication. The first number of RB interlaces are within each of the at least one RB set or across a plurality of the RB sets.

In some embodiments, the second terminal device 120 may receive a configuration of the first number of RB interlaces for the sub-channel from a set of candidate numbers of RB interlace, the set of candidate numbers corresponding to a sub-carrier space for the at least one RB set. The terminal device 120 may then determine the TBS based on the first number of RB interlaces.

In some embodiments, the second terminal device 120 may determine the TBS based on the first number of RB interlaces and the target interlace size.

In some embodiments, each of the at least one RB set may be associated with a respective interlace size, and the at least one transmission of the TB may comprise a plurality of transmissions of the TB. In this case, the second terminal device 120 may determine the TBS for each of the plurality of the transmissions based on at least one RB set associated with a same interlace size.

In some embodiments, the at least one RB set may comprise at least a first RB set and a second RB set, the first RB set is associated with a first interlace size, the second RB set is associated with a second interlace size, the first interlace size may be different from the second interlace size. In this case, the second terminal device 120 may determine the target interlace size for each interlace of the at least one RB set. The target interlace size may be one of the first interlace size, the second interlace size or an average value of the first interlace size and the second interlace size. The second terminal device 120 may then determine the TBS based on the first number of RB interlaces and the target interlace size.

In some embodiments, the at least transmission of the TB may comprise a plurality of transmissions of the TB. In this case, the second terminal device 120 may receive, from the first terminal device 110, SCI indicating the target interlace size for each interlace for transmitting a respective one of the plurality of transmissions of the TB.

In some embodiments, an RB set associated with the sidelink communication may comprise a second sub-channel comprising a second number of RB interlace and a third sub-channel comprising a third number of RB interlace, the second number is different from the third number.

In some embodiments, the second terminal device 120 may determine the first number of RB interlace for each sub-channel of the RB set. The first number may be one of the second number, the third number or an average number of the second number and the third number. The second terminal device 120 may determine the TBS based on the first number of RB interlace.

In some embodiments, the at least transmission of the TB comprises a plurality of transmissions of the TB. In this case, the second terminal device 120 may receive, from the first terminal device 110, SCI indicating the first number of RB interlace for each sub-channel for transmitting a respective one of the plurality of transmissions of the TB.

In some embodiments, the at least one transmission of the TB comprises at least one retransmission of the TB. In this case, the second terminal device 120 may determine a TBS for a previous transmission of the TB to be the TBS for the at least one retransmission of the TB. The previous transmission may comprise one of an initial transmission or a previous retransmission of the TB.

At block 630, the second terminal device 120 receives, from the first terminal device 110 and based on the TBS, the at least one transmission of the TB.

Detailed description related to the improvements for contiguous RB-based transmission in sidelink will be provided below. In this solution, the sub-channel for each RB set is individually defined based on the RB set configuration, thus the resource utilization efficiency can be improved.

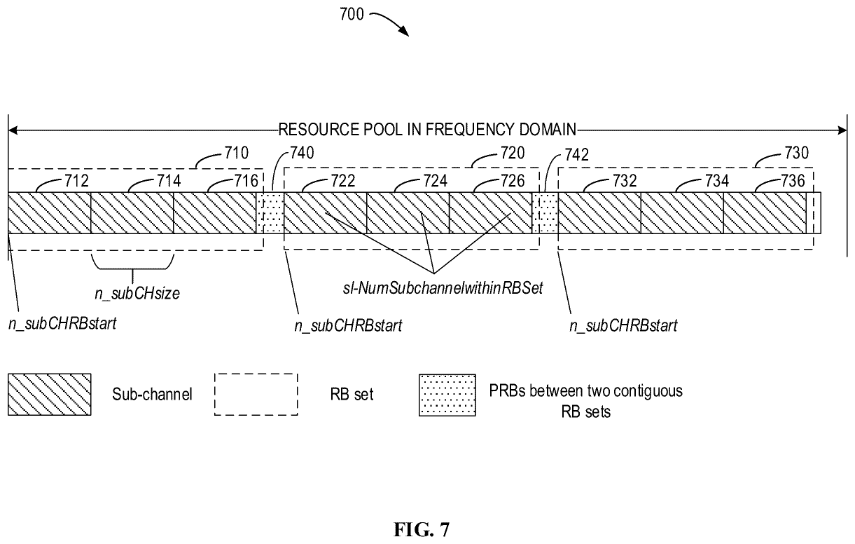

FIG. 7 illustrates a schematic diagram of an example configuration for contiguous RB-based transmission in sidelink according to some embodiments of the present disclosure. As shown in FIG. 7, in frequency domain, the resource pool 700 may comprise a plurality of RB sets 710 to 730. Additionally, the resource pool 700 may consist of a group of contiguous sub-channels 712 to 716, 722 to 726 and 732 to 736, which are defined within the plurality of RB sets 710 to 730, respectively.

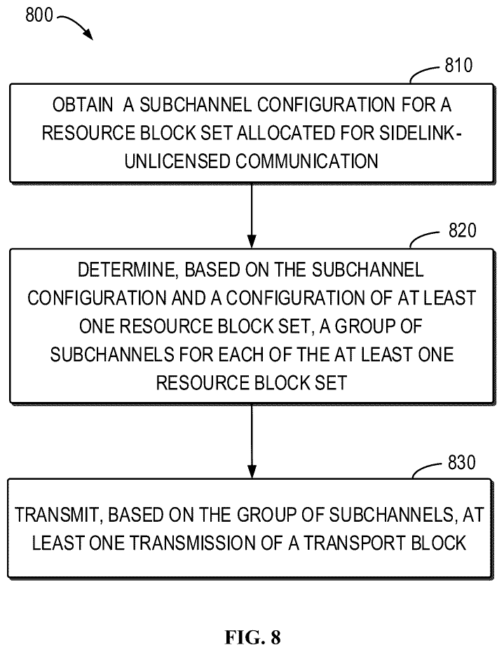

Reference is made to FIG. 8, which illustrates a flowchart of a process 800 for communication according to some example embodiments of the present disclosure. For the purpose of discussion, the process 800 will be described with reference to FIG. 1. The process 800 may be implemented at the first terminal device 110 and involve the second terminal device 120.

In the process 800, sidelink communication between the first terminal device 110 and the second terminal device 120 is based on contiguous RB-based transmission. At block 810, the first terminal device 110 obtains a sub-channel configuration for an RB set allocated for sidelink communication.

At block 820, the first terminal device 110 determines, based on the sub-channel configuration and a configuration of at least one RB set, a group of sub-channels for each of the at least one RB set. In this case, a starting position of the group sub-channels is aligned with a starting position of each RB set in frequency domain.

In some embodiments, the first terminal device 110 may determine a starting RB

$$( e . g . , R {B}_{s}^{s t art , μ} )$$

and an end

$$RB ( e . g . , {RB}_{s}^{end , μ} )$$

for each RB set with index s as below, where s∈{0, 1, . . . , N_{RB-set}−1} and N_{RB-set}−1 is the number of intra-cell guard bands as below:

$$R {B}_{s}^{s t art , μ} = {N}_{g r i d}^{s t art , μ} + \{ \begin{matrix}0 & s = 0 \\ G {B}_{s - 1}^{s t art , μ} + G {B}_{s - 1}^{s ize , μ} & otherwise\end{matrix} \qquad ( 1 )$$

$${RB}_{s}^{end , μ} = {N}_{g r i d}^{s t art , μ} + \{ \begin{matrix}{N}_{g r i d}^{s t art , μ} - 1 & s = {N}_{RB - set} - 1 \\ {GB}_{s}^{s t art , μ} - 1 & otherwise\end{matrix} \qquad ( 2 )$$

where μ is the SCS configuration,

$${N}_{g r i d}^{size , μ}$$

is the carrier size,

$${N}_{g r i d}^{start , μ}$$

is an starting RB of the resource block grid, GB^{Size,μ} is a size of a corresponding guard band, and GB^{start,μ} is an starting RB of the corresponding guard band.

In some example embodiments, the sub-channel configuration may include but not limited to a number of contiguous sub-channels within each RB set, a sub-channel size, etc. The first terminal device 110 may then determine a number of sub-channels within each of the determined RB sets individually. In the frequency domain, each RB set may consist of sl-NumSubchannelwithinRBSet contiguous sub-channels. A sub-channel may consist of sl-SubchannelSizewithinRBSet contiguous PRBs, where sl-NumSubchannelwithinRBSet and sl-SubchannelSizewithinRBSet are higher layer parameters.

Within each of the RB sets 710 to 730, a sub-channel m for m=0, 1, . . . , sl-NumSubchannelwithinRBSet−1 may consist of a set of n_{subCHsize} contiguous RBs with the PRB number n_{PRB}=n_{subCHRBstart}+m·n_{subCHsize}+j for j=0, 1, . . . , n_{subCHsize}−1, where n_{subCHsize} is given by higher layer parameters sl-SubchannelSizewithinRBSet, and n_{subCHRBstart} is the start CRB index of each RB set as determined respectively.

Since the first terminal device 110 as well the second terminal device 120 are not expected to use the last few PRBs in the RB set, for example, PRBs 740 and 742, which may be determined as N_{PRB} mod n_{subCHsize}, N_PRB is the PRB number of each of the RB sets 710 to 730.

At block 830, the first terminal device 110 transmits, to the second terminal device 120 and based on the group of sub-channels, at least one transmission of a TB.

In some embodiments, for contiguous PRB-based transmission, Listen-Before-Talk (LBT) should be performed in multiple RB sets which contains at least M contiguous RB sets in order to use N (N<=M) contiguous RB sets.

In some embodiments, the PRBs 740 and 742 between contiguous RB sets 710 to 730 is allowed for transmission or reception. In this case, the PRBs 740 and 742 may be considered as partial sub-channels, while sub-channels 712 to 716, 722 to 726 and 732 to 736 to be full sub-channels. The terminal device 110 may transmit SCI comprising a frequency resource indication (FRIV) for indicating the partial sub-channels 740 and 742 between two contiguous RB sets 710 to 730. Accordingly, the second terminal device 120 may decode the FRIV the SCI to know the final resource allocation.

Alternatively, or additionally, in some other embodiments, the PRBs 740 and 742 between contiguous RB sets 710 to 730 is allowed for transmission or reception. The first terminal device 110 may transmit the SCI comprising the FRIV which ignores the PRBs between two contiguous RB sets and only indicating the full sub-channels 712 to 716, 722 to 726 and 732 to 736 within RB sets. Accordingly, the second terminal device 120 may decode the FRIV from the SCI to know the indicated sub-channels 712 to 716, 722 to 726 and 732 to 736 and assume that the PRBs 740 and 742 between allocated sub-channels as included in the final allocated resource.

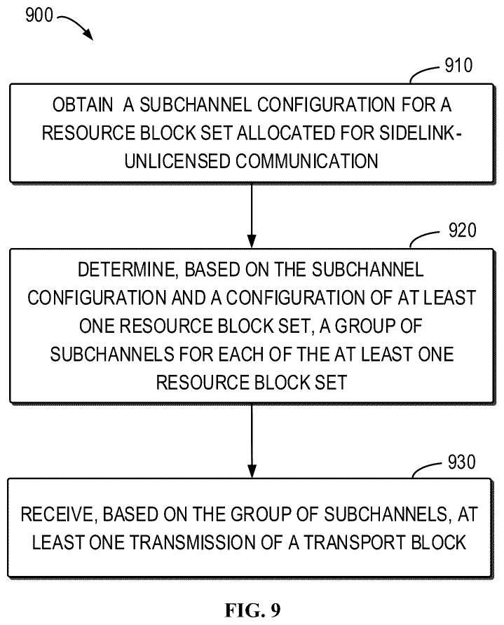

From the perspective of second terminal device 120, since the same sub-channel configuration is used, the same group of sub-channels will be obtained for sidelink communication, which will be described in detail below in connection with FIG. 9.

It would be appreciated that the examples, configurations and structures in FIG. 7 are given for the purpose of illustration. There will be many variants to resource allocation in frequency domain, and the scope of the present disclosure is not limited in this regard.

FIG. 9 illustrates a flowchart of an example method 900 in accordance with an embodiment of the present disclosure. The method 900 can be implemented at any suitable terminal devices. Only for the purpose of discussion, the method 900 will be described with reference to FIG. 1. For example, the method 900 may be implemented at the second terminal device 120.

At block 910, the second terminal device 120 obtains a sub-channel configuration for a resource block (RB) set allocated for sidelink communication.

In some embodiments, the sub-channel configuration is a RRC parameter may comprise at least one of the following: a target number of sub-channels in the group, or a target size of each of the group of sub-channels.

At block 920, the second terminal device 120 determines, based on the sub-channel configuration and a configuration of at least one RB set, a group of sub-channels for each of the at least one RB set. A starting position of the group sub-channels is aligned with a starting position of each RB set in frequency domain.

In some embodiments, the second terminal device 120 may determine, based on the configuration of the at least one RB set, at least the starting position of each of the at least one RB set in frequency domain. The second terminal device 120 may then determine the group of sub-channels starting from the starting position of each of the at least one RB set and comprising the target number of sub-channels contiguously distributed within each of the at least one RB set, each of the target number of sub-channels has the target size.

At block 930, the second terminal device 120 receives, from the first terminal device 110 and based on the group of sub-channels, at least one transmission of a TB.

In some embodiments, the second terminal device 120 may receive a transmission of TB on a plurality of contiguous RB sets in frequency domain.

In some embodiments, the second terminal device 120 may receive, from the first terminal device 110, a frequency resource indication (e.g., FRIV) of first sub-channels within the plurality of contiguous RB sets.

Additionally, or alternatively, in some embodiments, the frequency resource indication may further indicate at least one second sub-channel between two contiguous RB sets.

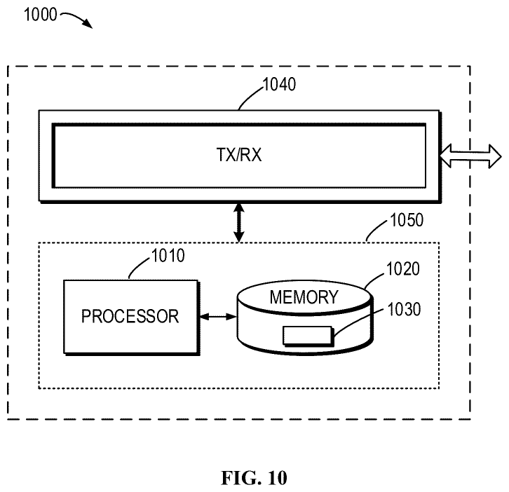

FIG. 10 is a simplified block diagram of a device 1000 that is suitable for implementing embodiments of the present disclosure. The device 1000 can be considered as a further example implementation of the first terminal device 110 or the second terminal device 120 as shown in FIG. 1. Accordingly, the device 1000 can be implemented at or as at least a part of the first terminal device 110 or the second terminal device 120.

As shown, the device 1000 includes a processor 1010, a memory 1020 coupled to the processor 1010, a suitable transmitter (TX)/receiver (RX) 1040 coupled to the processor 1010, and a communication interface coupled to the TX/RX 1040. The memory 1010 stores at least a part of a program 1030. The TX/RX 1040 is for bidirectional communications. The TX/RX 1040 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1030 is assumed to include program instructions that, when executed by the associated processor 1010, enable the device 1000 to operate in accordance with the embodiments of the present disclosure, as discussed herein with reference to FIGS. 1 to 9. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

In some embodiments, a communication device (e.g., the first terminal device) comprises a circuitry configured to: determine a sub-channel comprising a first number of resource block (RB) interlaces and each of the first number of RB interlaces having a target interlace size; determine, based on a target criterion associated with the sub-channel, a transport block size (TBS) for at least one transmission of a transport block (TB) for sidelink communication; and transmit, to another communication device (e.g., the second terminal device) and based on the TBS, the at least one transmission of the TB.

In some embodiments, at least one RB set is allocated for the sidelink communication. The first number of RB interlaces are within each of the at least one RB set or across a plurality of the RB sets.

In some embodiments, the circuitry is configured to determine the TBS based on the target criterion by: receiving a configuration of the first number of RB interlaces for the sub-channel from a set of candidate numbers of RB interlace, the set of candidate numbers corresponding to a sub-carrier space for the at least one RB set; and determining the TBS based on the first number of RB interlaces.

In some embodiments, the circuitry is configured to determine the TBS based on the target criterion by: determining the TBS based on the first number of RB interlaces and the target interlace size.

In some embodiments, each of the at least one RB set is associated with a respective interlace size, and the at least one transmission of the TB comprises a plurality of transmissions of the TB. The circuitry is configured to determine the TBS based on the target criterion by: determining the TBS for each of the plurality of the transmissions based on at least one RB set associated with a same interlace size.

In some embodiments, the at least one RB set comprises at least a first RB set and a second RB set, the first RB set is associated with a first interlace size, the second RB set is associated with a second interlace size, the first interlace size is different from the second interlace size. The circuitry is configured to determine the TBS based on the target criterion by: determining the target interlace size for each interlace of the at least one RB set, the target interlace size being one of the first interlace size, the second interlace size or an average value of the first interlace size and the second interlace size; and determining the TBS based on the first number of RB interlaces and the target interlace size.

In some embodiments, the at least transmission of the TB comprises a plurality of transmissions of the TB. The circuitry is further configured to: transmitting, to the other communication device, sidelink control information (SCI) indicating the target interlace size for each interlace for transmitting a respective one of the plurality of transmissions of the TB. In some embodiments, an RB set associated with the sidelink communication comprises a second sub-channel comprising a second number of RB interlace and a third sub-channel comprising a third number of RB interlace, the second number is different from the third number.

In some embodiments, the circuitry is configured to determine the TBS based on the target criterion by: determining the first number of RB interlace for each sub-channel of the RB set, the first number being one of the second number, the third number or an average number of the second number and the third number; and determining the TBS based on the first number of RB interlace.

In some embodiments, the at least transmission of the TB comprises a plurality of transmissions of the TB. The circuitry is further configured to: transmit, to the other communication device, SCI indicating the first number of RB interlace for each sub-channel for transmitting a respective one of the plurality of transmissions of the TB.

In some embodiments, the at least one transmission of the TB comprises at least one retransmission of the TB. The circuitry is configured to determine the TBS based on the target criterion by: determining a TBS for a previous transmission of the TB to be the TBS for the at least one retransmission of the TB, the previous transmission comprising one of an initial transmission or a previous retransmission of the TB.

In some embodiments, the at least one transmission of the TB comprises at least one of the following: an initial transmission of the TB, at least one retransmission of the TB.

In some embodiments, the target criterion is predetermined at the communication device and the other communication device.

In some embodiments, the target criterion is indicated via at least one radio resource control (RRC) parameter.

In some embodiments, a communication device (e.g., the second terminal device) comprises a circuitry configured to: determine a sub-channel comprising a first number of resource block (RB) interlaces and each of the first number of RB interlaces having a target interlace size; determine, based on a target criterion associated with the sub-channel, a transport block size (TBS) for at least one transmission of a transport block (TB) for sidelink communication; and receive, from another communication device (e.g., the first terminal device) and based on the TBS, the at least one transmission of the TB.

In some embodiments, at least one RB set is allocated for the sidelink communication, and the first number of RB interlaces are within each of the at least one RB set or across a plurality of the RB sets.

In some embodiments, the circuitry is configured to determine the TBS based on the target criterion by: receiving a configuration of the first number of RB interlaces for the sub-channel from a set of candidate numbers of RB interlace, the set of candidate numbers corresponding to a sub-carrier space for the at least one RB set; and determining the TBS based on the first number of RB interlaces.

In some embodiments, the circuitry is configured to determine the TBS based on the target criterion by: determining the TBS based on the first number of RB interlaces and the target interlace size.

In some embodiments, each of the at least one RB set is associated with a respective interlace size, and the at least one transmission of the TB comprises a plurality of transmissions of the TB. The circuitry is configured to determine the TBS based on the target criterion by: determining the TBS for each of the plurality of the transmissions based on at least one RB set associated with a same interlace size.

In some embodiments, the at least one RB set comprises at least a first RB set and a second RB set, the first RB set is associated with a first interlace size, the second RB set is associated with a second interlace size, the first interlace size is different from the second interlace size. The circuitry is configured to determine the TBS based on the target criterion by: determining the target interlace size for each interlace of the at least one RB set, the target interlace size being one of the first interlace size, the second interlace size or an average value of the first interlace size and the second interlace size; and determining the TBS based on the first number of RB interlaces and the target interlace size.

In some embodiments, the at least transmission of the TB comprises a plurality of transmissions of the TB. The circuitry is further configured to: receive, from the other communication device, sidelink control information (SCI) indicating the target interlace size for each interlace for transmitting a respective one of the plurality of transmissions of the TB.

In some embodiments, an RB set associated with the sidelink communication comprises a second sub-channel comprising a second number of RB interlace and a third sub-channel comprising a third number of RB interlace, the second number is different from the third number.

In some embodiments, the circuitry is configured to determine the TBS based on the target criterion by: determining the first number of RB interlace for each sub-channel of the RB set, the first number being one of the second number, the third number or an average number of the second number and the third number; and determining the TBS based on the first number of RB interlace.

In some embodiments, the at least transmission of the TB comprises a plurality of transmissions of the TB. The circuitry is further configured to receive, from the other communication device, SCI indicating the first number of RB interlace for each sub-channel for transmitting a respective one of the plurality of transmissions of the TB.

In some embodiments, the at least one transmission of the TB comprises at least one retransmission of the TB. The circuitry is configured to determine the TBS based on the target criterion by: determining a TBS for a previous transmission of the TB to be the TBS for the at least one retransmission of the TB, the previous transmission comprising one of an initial transmission or a previous retransmission of the TB.

In some embodiments, the at least one transmission of the TB comprises at least one of the following: an initial transmission of the TB, at least one retransmission of the TB.

In some embodiments, the target criterion is predetermined at the communication device and the other communication device.

In some embodiments, the target criterion is indicated via at least one radio resource control (RRC) parameter.

In some embodiments, a communication device (e.g., the first terminal device) comprises a circuitry configured to: obtain a sub-channel configuration for a resource block (RB) set allocated for sidelink communication; determine, based on the sub-channel configuration and a configuration of at least one RB set, a group of sub-channels for each of the at least one RB set, a starting position of the group sub-channels being aligned with a starting position of each RB set in frequency domain; and transmit, to another communication device and based on the group of sub-channels, at least one transmission of a transport block (TB).

In some embodiments, the sub-channel configuration is a RRC parameter comprising at least one of the following: a target number of sub-channels in the group, or a target size of each of the group of sub-channels.

In some embodiments, the circuitry is configured to determine the group of sub-channels by: determining, based on the configuration of the at least one RB set, at least the starting position of each of the at least one RB set in frequency domain; and determining the group of sub-channels starting from the starting position of each of the at least one RB set and comprising the target number of sub-channels contiguously distributed within each of the at least one RB set, each of the target number of sub-channels has the target size.

In some embodiments, the circuitry is configured to transmit at least one transmission of the TB by: transmitting a transmission of TB on a plurality of contiguous RB sets in frequency domain.

In some embodiments, the circuitry is further configured to: transmit, to the other communication device, a frequency resource indication of first sub-channels within the plurality of contiguous RB sets.

In some embodiments, the frequency resource indication further indicates at least one second sub-channel between two contiguous RB sets.

In some embodiments, a communication device (e.g., the second terminal device) comprises a circuitry configured to: obtain a sub-channel configuration for a resource block (RB) set allocated for sidelink communication; determine, based on the sub-channel configuration and a configuration of at least one RB set, a group of sub-channels for each of the at least one RB set, a starting position of the group sub-channels being aligned with a starting position of each RB set in frequency domain; and receive, from another communication device and based on the group of sub-channels, at least one transmission of a transport block (TB).

In some embodiments, the sub-channel configuration is a RRC parameter comprising at least one of the following: a target number of sub-channels in the group, or a target size of each of the group of sub-channels.

In some embodiments, the circuitry is configured to determine the group of sub-channels by: determining, based on the configuration of the at least one RB set, at least the starting position of each of the at least one RB set in frequency domain; and determining the group of sub-channels starting from the starting position of each of the at least one RB set and comprising the target number of sub-channels contiguously distributed within each of the at least one RB set, each of the target number of sub-channels has the target size.

In some embodiments, the circuitry is configured to receive at least one transmission of the TB by: receiving a transmission of TB on a plurality of contiguous RB sets in frequency domain.

In some embodiments, the circuitry is further configured to: receive, from the other communication device, a frequency resource indication of first sub-channels within the plurality of contiguous RB sets.

In some embodiments, the frequency resource indication further indicates at least one second sub-channel between two contiguous RB sets.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following solutions.

In one solution, a communication method: determining, at a first terminal device, a sub-channel comprising a first number of resource block (RB) interlaces and each of the first number of RB interlaces having a target interlace size; determining, based on a target criterion associated with the sub-channel, a transport block size (TBS) for at least one transmission of a transport block (TB) for sidelink communication; and transmitting, to a second terminal device and based on the TBS, the at least one transmission of the TB.

In some embodiments, at least one RB set is allocated for the sidelink communication, and the first number of RB interlaces are within each of the at least one RB set or across a plurality of the RB sets.

In some embodiments, determining the TBS based on the target criterion comprises: receiving a configuration of the first number of RB interlaces for the sub-channel from a set of candidate numbers of RB interlace, the set of candidate numbers corresponding to a sub-carrier space for the at least one RB set; and determining the TBS based on the first number of RB interlaces.

In some embodiments, determining the TBS based on the target criterion comprises: determining the TBS based on the first number of RB interlaces and the target interlace size.

In some embodiments, each of the at least one RB set is associated with a respective interlace size, and the at least one transmission of the TB comprises a plurality of transmissions of the TB, and determining the TBS based on the target criterion comprises: determining the TBS for each of the plurality of the transmissions based on at least one RB set associated with a same interlace size.

In some embodiments, the at least one RB set comprises at least a first RB set and a second RB set, the first RB set is associated with a first interlace size, the second RB set is associated with a second interlace size, the first interlace size is different from the second interlace size, and determining the TBS based on the target criterion comprises: determining the target interlace size for each interlace of the at least one RB set, the target interlace size being one of the first interlace size, the second interlace size or an average value of the first interlace size and the second interlace size; and determining the TBS based on the first number of RB interlaces and the target interlace size.

In some embodiments, the at least transmission of the TB comprises a plurality of transmissions of the TB. The method further comprises: transmitting, to the second terminal device, sidelink control information (SCI) indicating the target interlace size for each interlace for transmitting a respective one of the plurality of transmissions of the TB.

In some embodiments, an RB set associated with the sidelink communication comprises a second sub-channel comprising a second number of RB interlace and a third sub-channel comprising a third number of RB interlace, the second number is different from the third number.

In some embodiments, determining the TBS based on the target criterion comprises: determining the first number of RB interlace for each sub-channel of the RB set, the first number being one of the second number, the third number or an average number of the second number and the third number; and determining the TBS based on the first number of RB interlace.

In some embodiments, the at least transmission of the TB comprises a plurality of transmissions of the TB. The method further comprising: transmitting, to the second terminal device, SCI indicating the first number of RB interlace for each sub-channel for transmitting a respective one of the plurality of transmissions of the TB.

In some embodiments, the at least one transmission of the TB comprises at least one retransmission of the TB, and determining the TBS based on the target criterion comprises: determining a TBS for a previous transmission of the TB to be the TBS for the at least one retransmission of the TB, the previous transmission comprising one of an initial transmission or a previous retransmission of the TB.

In some embodiments, the at least one transmission of the TB comprises at least one of the following: an initial transmission of the TB, at least one retransmission of the TB.

In some embodiments, the target criterion is predetermined at the first terminal device and the second terminal device.

In some embodiments, the target criterion is indicated via at least one radio resource control (RRC) parameter.

In another solution, a communication method comprising: determining, at a second terminal device, a sub-channel comprising a first number of resource block (RB) interlaces and each of the first number of RB interlaces having a target interlace size; determining, based on a target criterion associated with the sub-channel, a transport block size (TBS) for at least one transmission of a transport block (TB) for sidelink communication; and receiving, from a first terminal device and based on the TBS, the at least one transmission of the TB.

In some embodiments, at least one RB set is allocated for the sidelink communication, and the first number of RB interlaces within each of the at least one RB set or across a plurality of the RB sets.

In some embodiments, determining the TBS based on the target criterion comprises: receiving a configuration of the first number of RB interlaces for the sub-channel from a set of candidate numbers of RB interlace, the set of candidate numbers corresponding to a sub-carrier space for the at least one RB set; and determining the TBS based on the first number of RB interlaces.

In some embodiments, determining the TBS based on the target criterion comprises: determining the TBS based on the first number of RB interlaces and the target interlace size.

In some embodiments, each of the at least one RB set is associated with a respective interlace size, and the at least one transmission of the TB comprises a plurality of transmissions of the TB, and determining the TBS based on the target criterion comprises: determining the TBS for each of the plurality of the transmissions based on at least one RB set associated with a same interlace size.

In some embodiments, the at least one RB set comprises at least a first RB set and a second RB set, the first RB set is associated with a first interlace size, the second RB set is associated with a second interlace size, the first interlace size is different from the second interlace size, and determining the TBS based on the target criterion comprises: determining the target interlace size for each interlace of the at least one RB set, the target interlace size being one of the first interlace size, the second interlace size or an average value of the first interlace size and the second interlace size; and determining the TBS based on the first number of RB interlaces and the target interlace size.

In some embodiments, the at least transmission of the TB comprises a plurality of transmissions of the TB. The method further comprises: receiving, from the first terminal device, sidelink control information (SCI) indicating the target interlace size for each interlace for transmitting a respective one of the plurality of transmissions of the TB.

In some embodiments, an RB set associated with the sidelink communication comprises a second sub-channel comprising a second number of RB interlace and a third sub-channel comprising a third number of RB interlace, the second number is different from the third number.

In some embodiments, determining the TBS based on the target criterion comprises: determining the first number of RB interlace for each sub-channel of the RB set, the first number being one of the second number, the third number or an average number of the second number and the third number; and determining the TBS based on the first number of RB interlace.

In some embodiments, the at least transmission of the TB comprises a plurality of transmissions of the TB. The method further comprises: receiving, from the first terminal device, SCI indicating the first number of RB interlace for each sub-channel for transmitting a respective one of the plurality of transmissions of the TB.

In some embodiments, the at least one transmission of the TB comprises at least one retransmission of the TB, and determining the TBS based on the target criterion comprises: determining a TBS for a previous transmission of the TB to be the TBS for the at least one retransmission of the TB, the previous transmission comprising one of an initial transmission or a previous retransmission of the TB.

In some embodiments, the at least one transmission of the TB comprises at least one of the following: an initial transmission of the TB, at least one retransmission of the TB.

In some embodiments, the target criterion is predetermined at the first terminal device and the second terminal device.

In some embodiments, the target criterion is indicated via at least one radio resource control (RRC) parameter.

In a further solution, a communication method comprising: obtaining, at a first terminal device, a sub-channel configuration for a resource block (RB) set allocated for sidelink communication; determining, based on the sub-channel configuration and a configuration of at least one RB set, a group of sub-channels for each of the at least one RB set, a starting position of the group sub-channels being aligned with a starting position of each RB set in frequency domain; and transmitting, to a second terminal device and based on the group of sub-channels, at least one transmission of a transport block (TB).

In some embodiments, the sub-channel configuration is a RRC parameter comprising at least one of the following: a target number of sub-channels in the group, or a target size of each of the group of sub-channels.

In some embodiments, determining the group of sub-channels comprises: determining, based on the configuration of the at least one RB set, at least the starting position of each of the at least one RB set in frequency domain; and determining the group of sub-channels starting from the starting position of each of the at least one RB set and comprising the target number of sub-channels contiguously distributed within each of the at least one RB set, each of the target number of sub-channels has the target size.

In some embodiments, transmitting at least one transmission of the TB comprises: transmitting a transmission of TB on a plurality of contiguous RB sets in frequency domain.

In some embodiments, the method further comprising: transmitting, to the second terminal device, a frequency resource indication of first sub-channels within the plurality of contiguous RB sets.

In some embodiments, the frequency resource indication further indicates at least one second sub-channel between two contiguous RB sets.

In still another solution, a communication method comprising: obtaining, at a second terminal device, a sub-channel configuration for a resource block (RB) set allocated for sidelink communication; determining, based on the sub-channel configuration and a configuration of at least one RB set, a group of sub-channels for each of the at least one RB set, a starting position of the group sub-channels being aligned with a starting position of each RB set in frequency domain; and receiving, from a first terminal device and based on the group of sub-channels, at least one transmission of a transport block (TB).

In some embodiments, the sub-channel configuration is a RRC parameter comprising at least one of the following: a target number of sub-channels in the group, or a target size of each of the group of sub-channels.

In some embodiments, determining the group of sub-channels comprises: determining, based on the configuration of the at least one RB set, at least the starting position of each of the at least one RB set in frequency domain; and determining the group of sub-channels starting from the starting position of each of the at least one RB set and comprising the target number of sub-channels contiguously distributed within each of the at least one RB set, each of the target number of sub-channels has the target size.

In some embodiments, receiving at least one transmission of the TB comprises: receiving a transmission of TB on a plurality of contiguous RB sets in frequency domain.

In some embodiments, the method further comprising: receiving, from the first terminal device, a frequency resource indication of first sub-channels within the plurality of contiguous RB sets.

In some embodiments, the frequency resource indication further indicates at least one second sub-channel between two contiguous RB sets.

In yet still solution, a communication device comprises: at least one processor; and at least one memory storing instructions that, when executed by the at least one processor, cause the device to perform any of the methods above.

In a further solution, a computer readable medium having instructions stored thereon, the instructions, when executed on at least one processor, causing the at least one processor to perform any of the methods above.

In a yet further solution, a computer program comprising instructions, the instructions, when executed on at least one processor, causing the at least one processor to perform any of the methods above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1.-19. (canceled)

20. A method performed by a terminal device, comprising:
receiving configuration information comprising a first number of interlaces per sub-channel within a resource pool and a second number of physical resource blocks (PRBs) of one interlace within one resource block (RB) set; and
determining, for interlace RB-based sidelink transmission, a transport block size (TBS) based on the first number of the interlaces and the second number of PRBs of one interlace.

21. The method of claim 20, wherein,
for sub-carrier space of 15 KHz, the first number is 1 or 2, or
for sub-carrier space of 30 KHz, the first number is 1.

22. The method of claim 20, wherein the second number is 10 or 11.

23. A terminal device, comprising a processor configured to:
receive configuration information comprising a first number of interlaces per sub-channel within a resource pool and a second number of physical resource blocks (PRBs) of one interlace within one resource block (RB) set; and
determine, for interlace RB-based sidelink transmission, a transport block size (TBS) based on the first number of the interlaces and the second number of PRBs of one interlace.

24. The terminal device of claim 23, wherein,
for sub-carrier space of 15 KHz, the first number is 1 or 2, or
for sub-carrier space of 30 KHz, the first number is 1.

25. The terminal device of claim 23, wherein the second number is 10 or 11.
